(19) United States
(12) Patent Application Publication
(10) Pub. No.: US 2004/0267660 A1
(43) Pub. Date: Dec. 30, 2004

(54) Risk management system

(75) Inventors: James E. Greenwood, Pottstown, PA (US); Kirk Spadt, Radnor, PA (US)

Correspondence Address: Paul Carango, DRINKER BIDDLE & REATH LLP, One Logan Square, 18th & Cherry Streets, Philadelphia, PA, 19103-6996, US

(73) Assignee: Automated Financial Systems, Inc., Exton, PA (US)

(21) Appl. No.: 10/785,364

(22) Filed: Feb. 23, 2004

Related U.S. Application Data
(60) Provisional application No. 60/448,470, filed on Feb. 21, 2003.

(51) Int. Cl. G06F 17/60

(52) U.S. Cl. 705/38; 705/30

(57) ABSTRACT

A risk management system is disclosed comprising a loan policy, at least one risk data system, and a risk system for assessing and evaluating risk. In addition, a method of risk management is disclosed, comprising: establishing a loan policy; monitoring data from a risk data system; comparing the data to the loan policy; recording a risk event if a deviation occurs between the data and the loan policy; performing a risk assessment of the risk event; and enabling a user the access the results of the risk assessment.

### CLAIM OF PRIORITY

This application claims priority from U.S. provisional patent application No. 60/448,470, filed Feb. 21, 2003, the contents of which are incorporated fully by reference herein.

### FIELD OF THE INVENTION

The current invention relates to the field of risk management, specifically to a system for risk assessment, risk evaluation, identifying, analyzing, quantifying, reporting and prioritizing risk, and providing a means of working and understanding areas of risk associated with financial portfolios, financial instruments, financial institutions and the lending process.

### BACKGROUND

Risk management is a critical issue for financial survival of financial institutions such as banks. Due to the unpredictable nature of financial portfolios, risk must be assessed and managed in an efficient manner. In addition, due to recent legislation such as the Basel Capital Accord II, the Patriot Act, and the Sarbanes/Oxley Act, it is becoming more and more essential for financial institution managers to be able to meaningfully understand, manage and assess risk. Other financial and economic factors drive risk, including shareholders, regulators, FASB, SEC, ratings agencies, etc. Poor portfolio risk management continues to be one of the financial and banking industries largest problems.

Financial institutions face a number of different risks that expose them to possible losses. These risks include operational risk, credit risk, market risk, liquidity risk, legal risk, insurance risk, etc., all of which are within the scope of the term “risk” as used herein.

Operational risk comprises the risk of loss resulting for inadequate or failed internal processes, procedures, people and technology. Operational risk can be thought of as the risk resulting from an incident, for example, a breakdown in transactional processing or compliance issues, due to systems or procedural failures, human errors, disasters or illegal activity.

Credit risk arises from the potential that a borrower will fail to perform on an obligation; the risk that borrowers will be unable to meet their obligations to the lender. Credit risk can also be thought of as the measure of a borrower's ability to repay a loan as promised, or a person's or company's creditworthiness, as reported on a credit rating.

Market risk is the likelihood that the value of a security will move concurrently with its overall market.

Liquidity risk is the risk of loss arising from a lender failing to meet funding requirements at any given time.

There are, of course, many other types and kinds of risk that may arise when a financial institution is providing services to a financial client.

Current methods for assessing risk in connection with servicing financial clients are not adequate. Generally, under current methods, risk management is an afterthought. Risk is not assessed through an ongoing system that accessed numerous data points to provide a thorough analysis.

The assessment of operational risk is not a widely performed exercise in financial institutions, other than as an audit function imposed by a particular department, or by an independent auditor. Various types of risk are reviewed by different departments within a financial institution from specific orientation perspectives.

The financial institution's overall strategic risk with respect to, for example, its loan management function is a review process that may occur in as many ways as management requires. There is no generally recognized system or approach. This is problematic, since risk management is essential during the life of any loan or other financial instrument, and must take place on an ongoing basis.

A loan accounting system, or other similar accounting system, utilized by a financial institution may have capabilities to provide information on loan service, such as balancing, past dues, new loans, maturity, margining of collateralized loans, and departmental concerns. The loan accounting system may comprise data that in conjunction with other systems provides a potential basis for the review of the financial institution's portfolios and related risk. Unfortunately, the valuable information that is gathered is not often used by financial institutions in a meaningful way to identify or manage risks.

Financial institutions often have policies in place, rules or guidelines, to be used when servicing clients'financial portfolios. However, while a financial portfolio is serviced by a financial institution, a decision is sometimes made to deviate from the preset rules or guidelines. Deviation from these rules or guidelines creates risks. In addition, after a loan has been processed, many events or variables can create additional risks.

However, under currently known systems, there is no way to automatically capture, either globally, efficiently, or in real-time, the level of risk posed by the loans or other instruments being serviced by a financial institution, or to easily access and view information regarding the current level of risk posed to a financial institution. There is also currently no way to automatically capture, in real-time, the types of risk posed by financial portfolios being serviced by the financial institution.

There is a wealth of information that may be helpful to a financial institution in assessing risks. However, at this time, this information has not been collected in one system in a useful manner for the purposes of risk management. There are many disparate data sources that must be tied together in order to receive a full picture of risk.

Thus, there currently exists the need for an automated risk management system capable of identifying the risks presented to a financial institution.

There further exists the need for an automated risk management system that assists financial institutions in managing risks in order to decrease losses.

There further exists the need for an automated risk management system that assists financial institutions in managing risks in order to meet statutory or legislative reporting requirements.

There is further the need for an automated risk management system that is capable of accessing various risk data systems comprising data that may impact a financial institution's risk.

There is even further the need for an automated risk management system that compiles data from different sources and evaluates such data in a way that is meaningful for assessing risk.

### SUMMARY OF THE INVENTION

The risk management system of the present invention comprises a computer program for risk assessment and risk evaluation, including, but not limited to, identifying, quantifying, analyzing, prioritizing, combining, reporting and managing the various types of risk associated with the services provided by a financial institution. The system of the present invention generally comprises the combination of a loan policy, at least one risk data system, and an automated risk system having risk assessment and risk evaluation capabilities. A goal of the system is to assess, evaluate, communicate and manage risk in the lending process. Risk management is required at all times while a financial institution is servicing a financial client.

A loan policy is provided, as a set defining of rules and/or parameters and/or guidelines set by a financial institution for processing financial instruments. Various risk data system are provided comprising data that may impact risk associated with a financial portfolio, and that data is compared to the loan policy, to determine if there are any deviations from the loan policy. Any deviation is deemed a risk event.

A risk system is provided for collecting risk event data, and assessing and evaluating such data. The risk system generally comprises a risk rule engine having access to a risk analysis file. The risk system can also access the various risk data systems.

The risk management system is designed to collect, process, analyze, assess, evaluate, and report data from the various risk data systems for assessing risks relating to financial instruments and/or financial portfolios serviced by a financial institution. In addition, the risk management system of the present invention is designed to process information on an ongoing basis as needed to provide risk assessment and risk evaluation.

As a financial instrument or financial portfolio is processed by a financial institution, where actions are taken deviating from a set loan policy, such actions are logged by the system as risk events. The risk system has access to various risk data systems and files, for monitoring, analyzing, assessing, evaluating, calculating and communicating risk associated with any risk event.

A risk rule engine is provided, comprising a means for gathering data associated with risks, performing risk assessment and/or risk evaluation. Various reporting functions are provided by the risk system, as well as a user interface for allowing user's to review the results of risk assessment. One consequence of the risk management system of the present invention is an ability to tie together appropriate data from various sources and to assess risk in a significant manner. Using the system of the current invention, a financial institution has the ability to analyze risk events, individually or collectively, to determine the best manner of controlling and reporting risk.

### DETAILED DESCRIPTION OF THE DRAWINGS

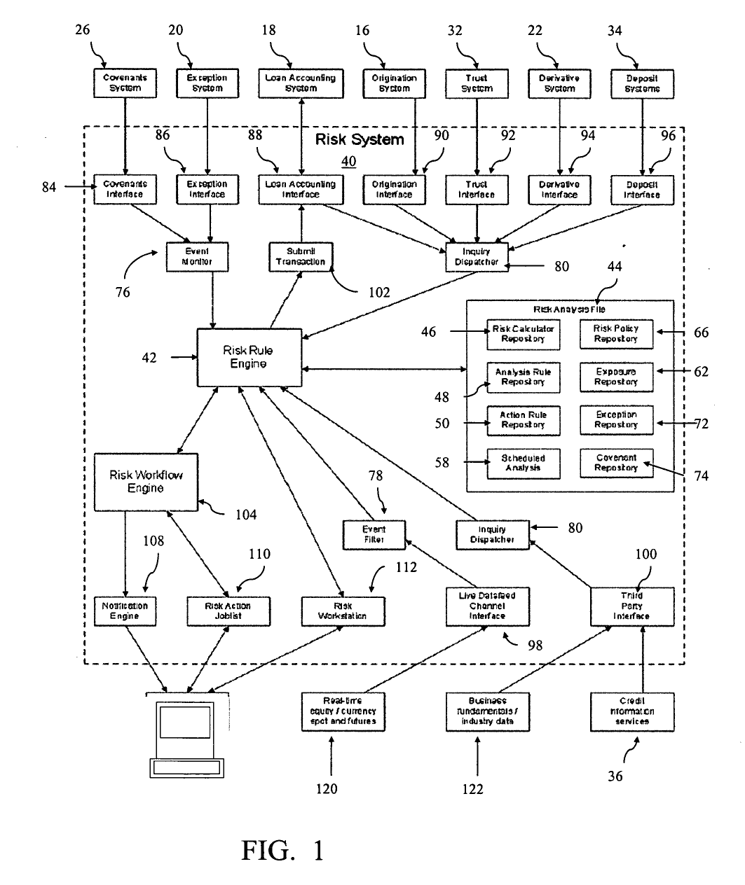

FIG. 1 is a block diagram of an embodiment of the risk management system of the present invention.

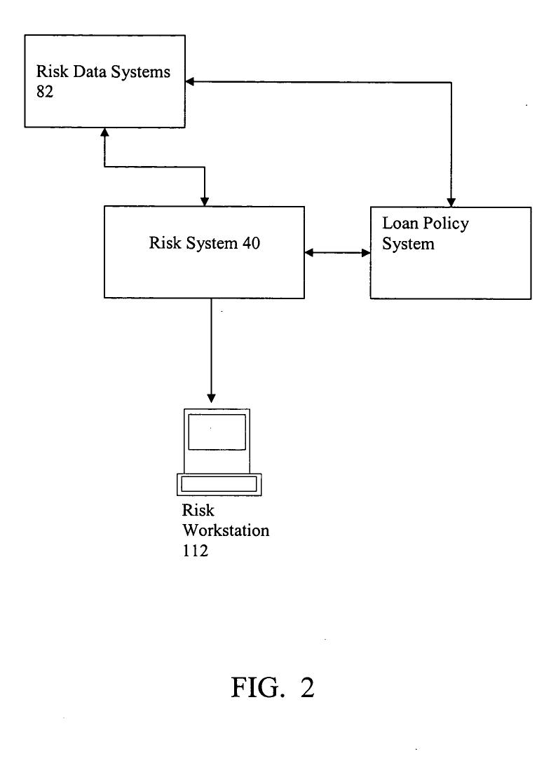

FIG. 2 is a block diagram overview of the risk data systems, loan policy systems, and risk system of the present invention.

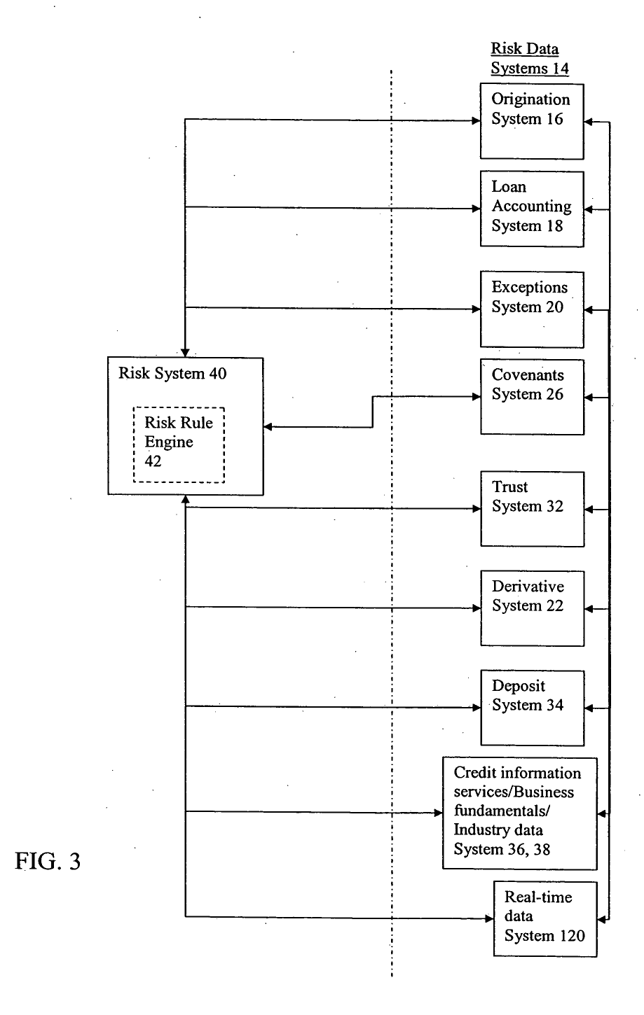

FIG. 3 is a block diagram of the risk data systems, the risk system, and the risk rule engine of the present invention.

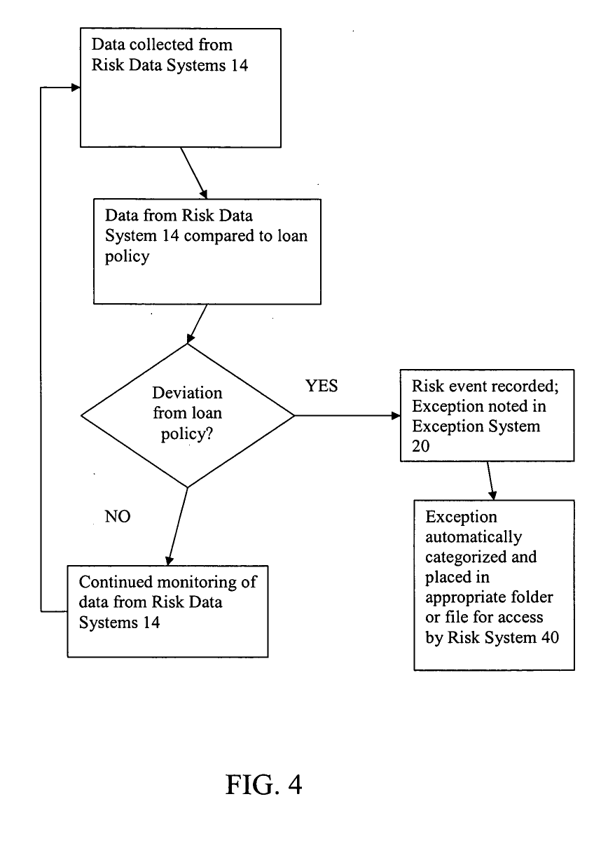

FIG. 4 is a flow chart showing how risk events can be recorded according to the present invention.

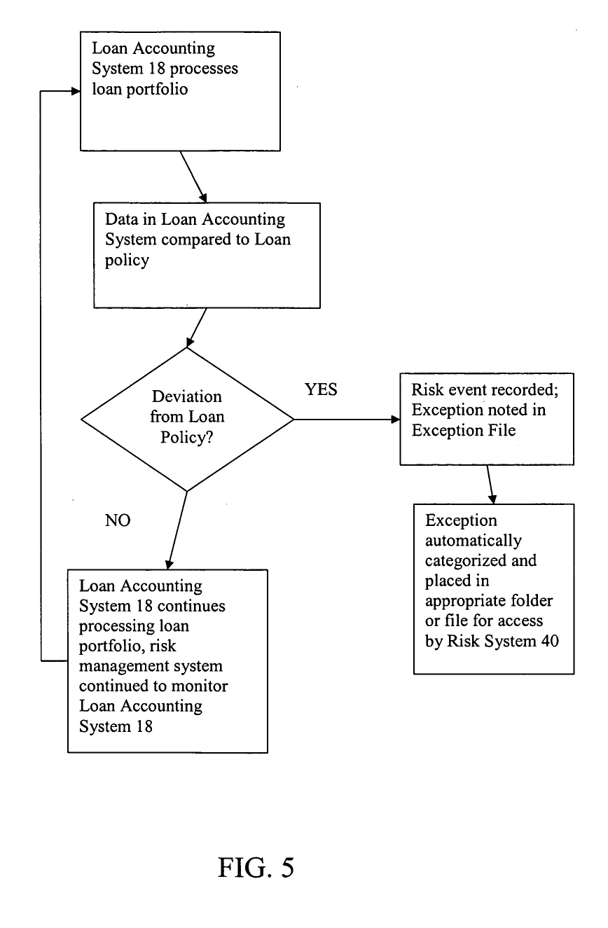

FIG. 5 is a flow chart showing how risk events can be recorded according to the present invention.

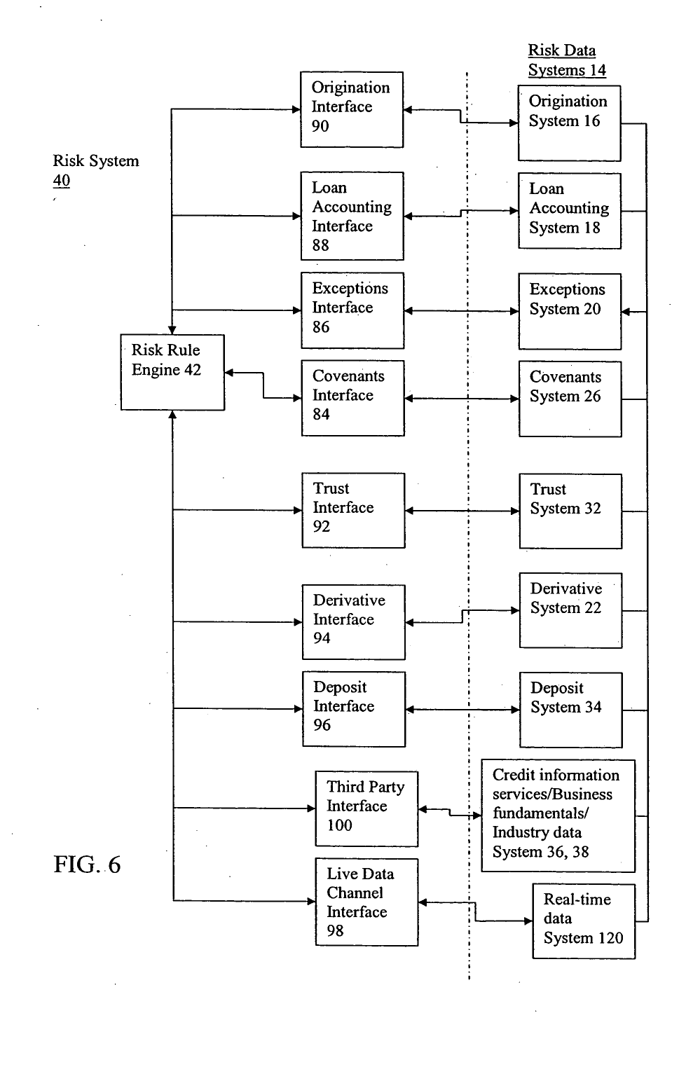

FIG. 6 is a block diagram of the risk data systems, system interfaces, and risk rule engine of the present invention.

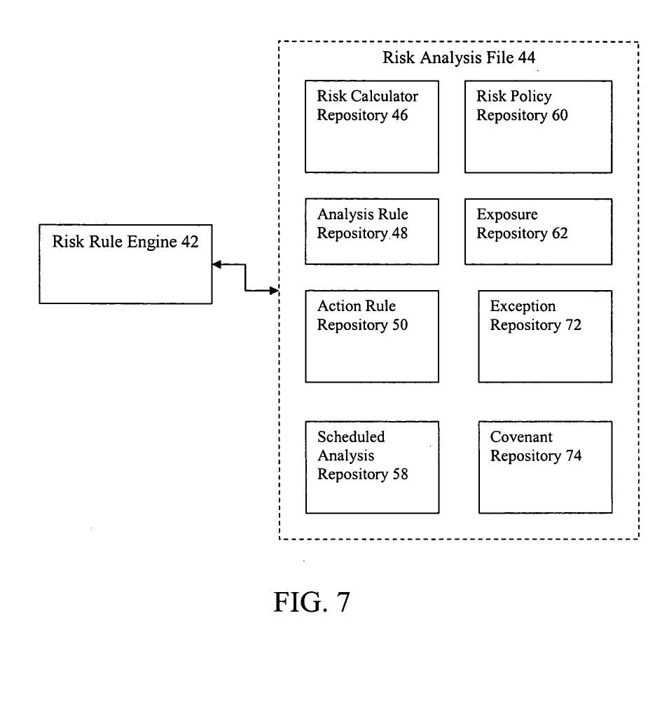

FIG. 7 is a block diagram of the risk analysis file and risk rule engine of the present invention.

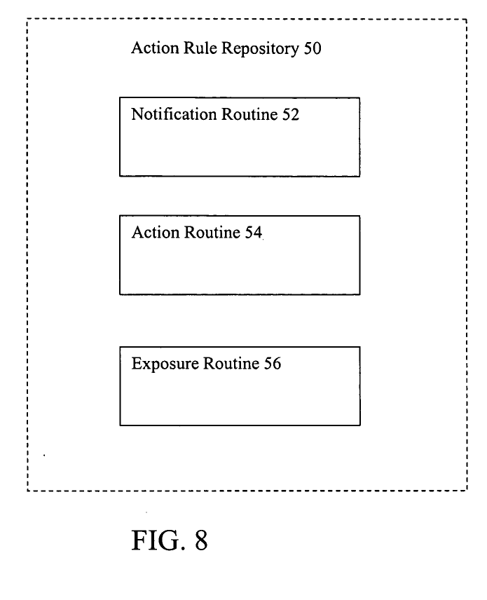

FIG. 8 is a block diagram of the action rule repository of the present invention.

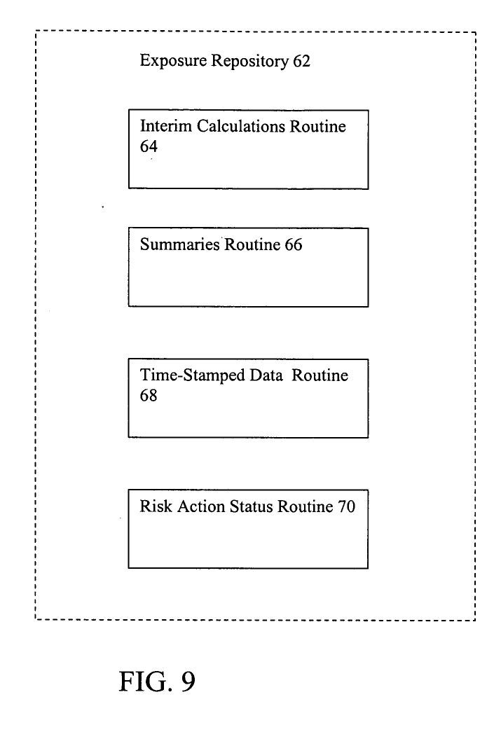

FIG. 9 is a block diagram of the exposure repository of the present invention.

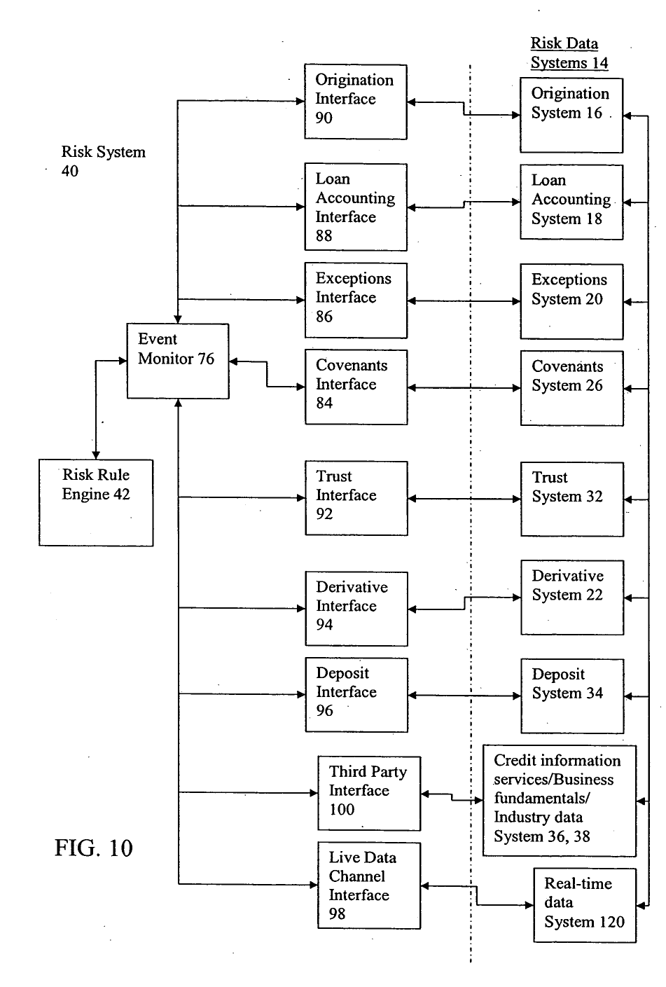

FIG. 10 is a block diagram of the risk data systems, system interfaces, event monitor, and risk rule engine of the present invention.

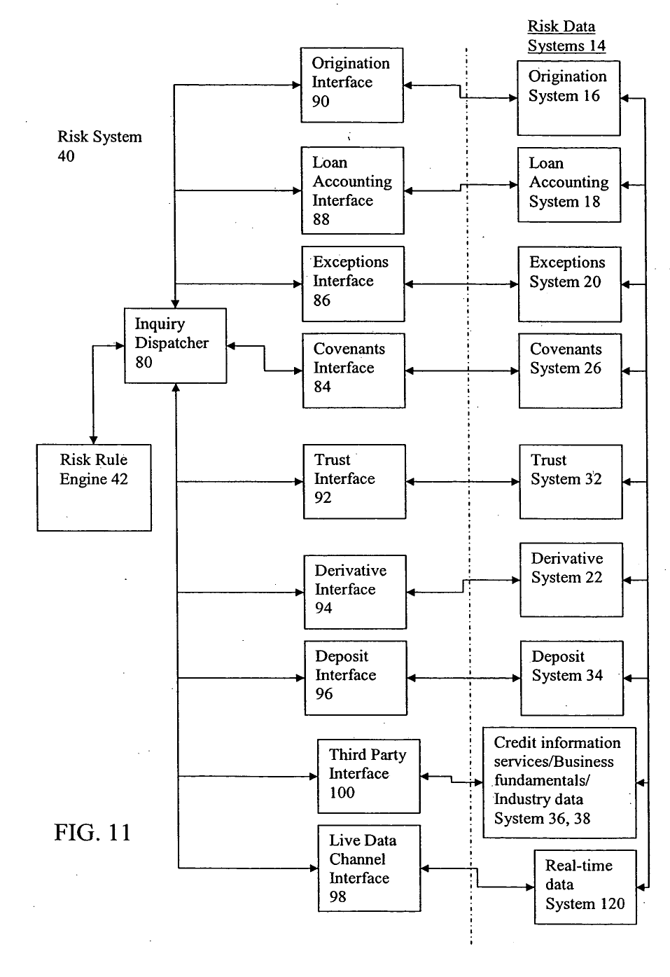

FIG. 11 is a block diagram of the risk data systems, system interfaces, inquiry dispatcher, and risk rule engine of the present invention.

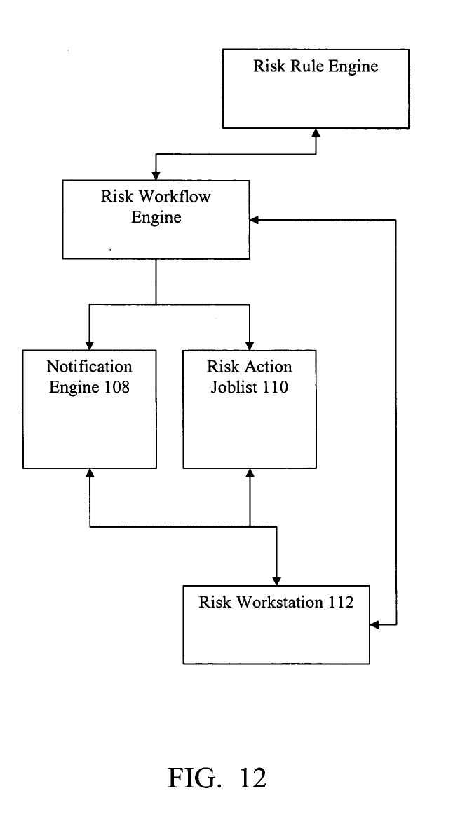

FIG. 12 is a block diagram of the risk rule engine, risk workflow engine, notification engine, risk action joblist and risk workstation of the present invention.

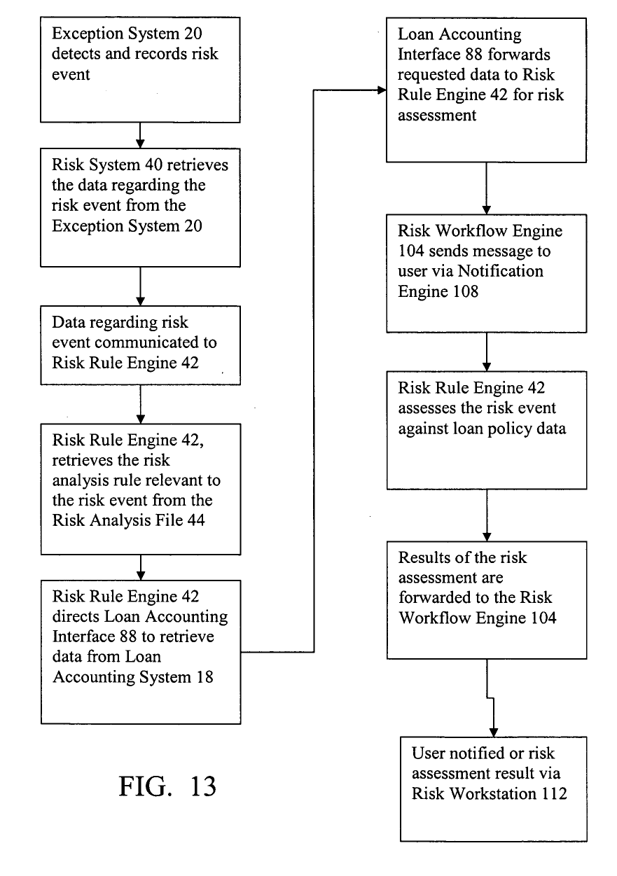

FIG. 13 is a schematic representation showing an illustrative operation of the present invention in assessing risk.

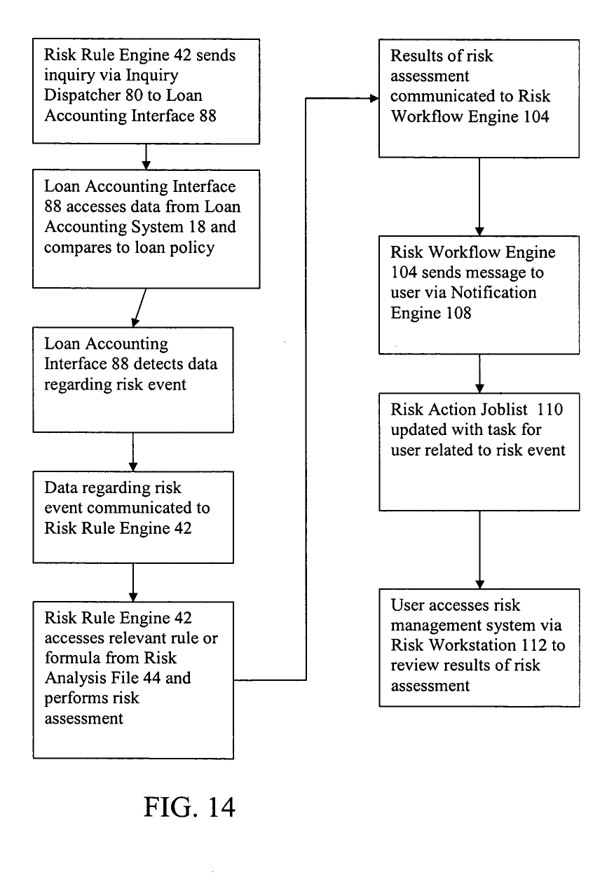

FIG. 14 is a schematic representation showing an illustrative operation of the present invention in assessing risk.

### DETAILED DESCRIPTION OF THE INVENTION

The risk management system of the present invention, referred to overall as a “risk management system,” with an illustrative embodiment shown in FIG. 1, is capable of assessing and allowing users to identify, monitor, analyze, evaluate, and manage each type of risk that may arise during a financial institution's servicing of user's financial portfolios. In an illustrative embodiment of the present invention, the risk management system is implemented as a computer program, comprising software application and data files. The computer program is stored on at least one computer that may comprise a processing unit or CPU, with a memory capacity for storing the information gathered by the system, which can be through various technical means as will be appreciated by those in the art. The computer program is accessible by users of the system through a user interface, such as a personal computer terminal having a CPU, keyboard, monitor and mouse, or thin client server comprising a terminal with a keyboard, monitor and mouse.

The term “client” as used herein refers to any customer serviced by a financial institution.

The term “computer program,” as used herein, comprises any computer software application or combination of computer software applications, comprising sets of coded instructions that enable a computer to perform desired sequences of operations, and data as required to support those operations. Data may be stored in files, databases, data stores, etc. The computer program can be in any computer language or computer code.

The term “data” as used herein comprises any data, information, procedure, event, action or occurrence.

As used herein, the terms “financial institution,” “user,” or “lender” refer to any entity that deals in financial instruments during the course of its business and may utilize the risk management system.

The term “financial portfolio” as used herein means any single or collection of financial instruments serviced by a financial institution for a client. A loan portfolio as used in the description of the invention is one example of a financial portfolio, but does not limit the scope of the invention.

The term “financial instrument” as used herein comprises any legally enforceable agreement between two or more parties, expressing a contractual right or a right to the exchange of money or money-equivalents. Financial instruments include, but are not limited to, loans, mortgages, checks, drafts, notes and bonds. Discussions regarding loans are used by way of example of one type of financial instrument, and do not limit the scope of the invention.

The term “real-fime data feed” as used herein, means any accessible financial or credit industry transactions or data that can be accessed over a computer network as it actually occurs, or with negligible delays.

The terms “risk assessment” or “risk analysis” as used herein are interchangeable and comprise the analyzing, monitoring, measuring, assessment, comparing, combining, management, tracking, identification, quantification, calculation, reporting, communication, prioritizing and/or evaluation of risk.

The term “risk evaluation” as used herein generally comprises the process used to determine risk management priorities by comparing the level of risk against predetermined standards or rules or values, target risk levels or other criteria. Risk evaluation further comprises a comparison of the results of a risk assessment with risk assessment criteria and other data that may impact risk assessment.

As used herein, a “risk event” is any data, information, procedure, event, action or occurrence that has the potential to impact the risk to a financial institution or financial portfolio serviced by a financial institution. As those in the art of finance, banking or commercial lending will appreciate, there are many actions that may result in a risk event. Deviations from set policies, also known as exceptions, are just one example of a risk event. A risk event reflects the data, information, procedure, event, action or occurrence that deviates from the loan policy. The risk management system of the present invention is designed to track, monitor and analyze risk events, as well as to provide users with a means to review risk events, and take action in response to risk events.

The term “risk management” as used herein comprises a general term describing the process of analyzing risk in all aspects of management and operations, the development and execution of strategies or actions to reduce the exposure to such risks, the monitoring of such actions, and the reporting or communication of risk or potential risk to appropriate parties.

The term “system” or “computer system” as used herein is broadly used to refer to a computer program, computer file or collection of computer files, applications, data files, data stores, interfaces, or any combination thereof. The term “system” is included within the definition of computer program.

For reference purposes, FIG. 1 shows an overall schematic depiction of one embodiment of a risk management system according to the present invention.

I. The Loan Policy

A loan policy is established by a financial institution comprising a set of rules, guidelines and/or parameters, referred to collectively herein as “loan policy rules,” to be used when considering, accepting, processing, tracking and otherwise servicing a financial instrument. The loan policy may be implemented as a computer database or computer program, or combination thereof. The set of rules comprising the loan policy will dictate permissible actions that may be taken when a financial institution is determining whether to grant a loan to a potential loan customer.

The following is a non-exhaustive list of potential areas where loan policy rules may be set to establish the loan policy: limits on loan officer permitted approval, such as dollar limits; limits on loans to particular industries, such as dollar limits; derivative limits; limits on loan lacking liquid collateral; limits on loans to country, by limiting geographic area or setting dollar limits; limits on loan to particular individuals; setting rules for acceptable credit ratings in order for loans to proceed; setting rules for loans requiring credit committee approvals; setting rules for certain loan being combined with an acceptable derivative or offsetting sale of the credit; rules regarding prepayment agreed structures documentation of legal perfection; rules regarding loans needing more than one authorization; rules regarding loans in origination; rules regarding when and how the Exception System (discussed below) should be accessed and reviewed during loan processing; customers, sales, decision making, approval, perfecting, booking, and data gathering.

It is appreciated that those in the financial and lending industry are aware of other related areas where loan policy rules may be set. It also appreciated that the limits discussed herein comprising the loan policy may relate to organizational, financial, temporal, and/or geographic limits. In addition, a user may set individual limits based on any preferences and have these as integral parts of the loan policy. Deviations from the loan policy result in an exception.

The loan policy may be integrated into the system in several ways. In an illustrative embodiment, a Loan Policy System 12 comprises the loan policy, and houses the rules, guidelines and/or parameters. The Loan Policy System 12 may be a computer program, a database or combination of databases stored on at least one computer, or a combination thereof. The Loan Policy System 12 may be accessed by other components of the system as needed when processing a loan. The loan policy may also be built into the Loan Accounting System 18, the Origination System 16, or the Risk Rule Engine 42, as discussed in more detail below. The loan policy is a reference against which actions can be measured and evaluated.

The Loan Policy System 12 comprises the loan policy that a financial institution believes are required in order to determine whether to grant a loan to a client or service a financial instrument for a client, for legal, regulatory and/or business reasons, as well as other rules or policies deemed necessary for properly processing a loan or other financial instrument. The loan policy may also be considered the rules, guidelines and/or parameters for acceptable actions that may be taken during the loan management process when managing a financial portfolio.

By way of example, included in the Loan Policy System 12 may be the set loan policy of the specific financial institution, the financial institution's strategic policy as determined by management, the credit policy of the financial institution, and various departments'operational policies within the financial institution. These different policies combine to create the loan policy.

As stated, a loan policy is established by a user of the system, or established in conjunction with the input of a user. The loan policy provides one of the foundations for the risk management system to produce exceptions, or comparative data, in order to identify risks.

For illustrative purposes, examples of loan policy would be rules established by a financial institution that the aggregate amount of approved loans to borrowers in a certain industry must not exceed a suggested limit, compared to the aggregate base for all other loans. In this example, the risk initially occurs, and would be identified, when the aggregate amount in a specific industry rises above the established limit. There are many factors to be analyzed, such as collateral term credit rating, etc. Other examples would be where an individual loan officer has personal authority or monetary limits that may not to be exceeded, where loans to foreign countries may have certain monetary or regulatory limits, or where the government may have restrictions on a class of potential borrowers.

Other loan policies may be set to be considered when allowing a loan. For example, a financial institution may have a limit on the size (monetary amount) of an acceptable loan. Accordingly, under the loan policy, the origination of the loan may be stopped or redirected if the loan is in excess of the loan policy limit during the loan origination process, discussed further below. Alternatively, there may be policies that require a response to the result which occurs due to approval of the loan rather than cessation of the loan process itself. These are loan policies that work with results. For example, the individual loan size may be within policy limits; however, the total portfolio cannot exceed a certain total. Steps may need to be taken after approval to perfect a loan, get collateral delivery, or receive loan perfection. FIG. 2 is a block diagram of the Loan Policy System 12, in communication with the Risk Data Systems 14, and the Risk System 40.

II. Risk Data Systems

In addition to data that may be drawn from the Loan Policy System 12, at least one of various Risk Data Systems 14 is provided or made available from which information may be extracted and processed as part of the risk management system of the invention.

Data that may be pertinent to risk assessment or risk evaluation comes from many sources, internal and external to a financial institution. Internal data pertinent to risk assessment and risk evaluation may include, but is not limited to: information regarding financial portfolios serviced by the financial institution; information regarding financial instruments serviced by a financial institution; information gathered during origination; and, information from the loan accounting system. External sources of data pertinent to risk assessment and risk evaluation may include, but is not limited to: outside credit ratings; country risks; company risks, such as a particular company's collateral, employer, borrower; industry risks, such as a particular industry's collateral, employer, borrower; guarantor risk; occupant risk; interest rate data; weather data; global conflict data; payments; parties in credit derive; credit swaps; or covenants. The Risk Data Systems 14 are designed to capture at least a portion of this data.

The Risk Data Systems 14 may comprise data files, databases, computer programs, financial software systems, or external information services, as well as real-time data feeds that can be received through a computer network. These are discussed in detail below.

A. Origination System

Origination is generally a servicing and information intake step for managing and supporting a financial portfolio. Data pertaining to a financial portfolio such as a loan portfolio may be gathered in an Origination System 16 such as through an origination step controlled by or in conjunction with the loan policy. During the origination step, information necessary for processing a financial portfolio is gathered. For example, the information needed on a loan application may be gathered during the origination step. Numerous factors impact the loan decision, that is, whether a loan will be granted or refused by a financial institution. These factors differ according to the type of loan. The origination step may be designed to collect the information needed for processing each type of loan in an Origination System 16. It is also appreciated that information relating to a financial portfolio may be collected by a source outside a financial institution, and later transferred the financial institution. Such information may be stored in the Origination System 16, or another Risk Data System.

According to the risk management system of the present invention, information gathered in the Origination System 16 is automatically reviewed by the system. This automated origination review may occur prior to the loan approval, such as during an initial loan request, or the automated origination review may begin after approval but prior to entry of the information concerning the loan into a loan accounting system, or through one of the systems Inquiry Dispatchers 80, discussed below. The automated origination review allows the system to access the Loan Policy System 12, and compare the loan policy to the information gathered during origination.

In an alternate embodiment, the loan policy may be built directly into the Origination System 16, such as in the form of a rules engine. During the origination step, the system may also access information from and communicate with a Loan Accounting System 18, as discussed in more detail below. It is contemplated that the Origination System 16 may be implemented as a computer program running on at least one computer.

In an ongoing process, all discrepancies between the loan policy and the Origination System 16, or any actions occurring during origination, or any deviations, departures or variances from the set loan policy, are considered exceptions, and information relating to such exceptions to the set loan policy are recorded in the Exception System 20, which is discussed in greater detail below. An exception is triggered each time an action taken with respect to a particular loan deviates from the established loan policy. This occurs automatically within the risk management system utilizing a computer program designed to track such deviations. Exceptions may be triggered by individual risk events, or by risk events occurring in combination, providing for an ongoing automated evaluation of risk.

The risk management system is further designed to handle departures from the loan policy having different magnitudes or levels of potential risk. For example, depending on how the automated origination review process is designed, an exception to the loan policy may be so severe, and such a major violation of loan policy, that the system is automatically designed to completely reject the loan, such as through the Transaction Submission System 102, and stop a user of the system from processing the loan any further. The risk management system may reject certain actions attempted during origination. If the exception is not a major violation of the loan policy, the system may be set to allow the loan process to continue while noting the presence of an exception in the Exception System 20. In addition, the risk management system may have the capability to track all rejections and exceptions, as well the specific user initiating an action resulting in an exception.

B. Loan Accounting System

A Loan Accounting System 18, as used herein, comprises a computerized automated lending solution for processing loans. A Loan Accounting System 18 may also comprise a computerized automated solution for processing a myriad of financial instruments. An example of such a system is described in detail in U.S. Published patent application US20020152155A1, “Method For Automated And Integrated Lending Process,” the entire contents of which are fully incorporated herein by reference. An origination step or origination system may be integrated into the Loan Accounting System 18. The Loan Accounting System 18 may be considered, generally, a computer program designed for processing loans.

As a financial instrument such as a loan is processed by the Loan Accounting System 18, risk events may occur at any stage during the process. Exceptions may be triggered when actions deviate from the loan policy. Example of the many potential exceptions that could occur while a financial instrument is processed by the Loan Accounting System 18 include, but are not limited to: a loan going past maturity; a loan over margin; the margining of collateral indicating insufficient collateral value; situations where additional administrative steps are needed after initial loan approval; where a loan is approved for an industry not included within the loan policy; where a loan is approved for a maturity longer than allowed by the loan policy; where a loan is awaiting lien perfection; where collateral for a loan is to be forwarded by a stock broker to the financial institution; where a loan has not yet been sold; where a credit derivative has not yet been received by a financial institution; where a borrower's credit rating is below the limit set in the loan policy; where a debt limit is exceeded in a covenant; where a loan is approved without going through all the required steps prior to approval; where the debt to equity ratio falls outside a covenant; where a borrower's credit rating has dropped; or, where the borrower's income level drops below a threshold set in a covenant. All of these exceptions are risk events that must be monitored by the system.

The Loan Accounting System 18 is in communication with the Loan Policy System 12, the other Risk Data Systems 14, and Risk System 40, as described in more detail below. The Loan Accounting System 18 may also be in communication with a Loan Accounting Interface 88 to facilitate communication with the Risk Rule Engine 42 of the Risk System 40 as described in more detail.

C. Exception System

Any deviation or variance from the loan policy, regardless of where in the risk management system it occurs, is considered an exception, and all data concerning exceptions is collected in an Exception System 20, which is implemented as a computer program. Each exception is considered a risk event. Exceptions may be generated at any stage during a financial institution's servicing of a user's financial instruments or financial portfolio. The Exception System 20 is adapted to collect all of the exceptions that occur during the processing and life of a financial portfolio such as a loan portfolio. The Exception System 20 may be in communication with one or more of the other components of the risk management system, such as the Loan Accounting System 18, the Risk Data Systems 14, and the Risk System 40, as discussed in more detail below. The communication between the Exception System 20 and the various Risk Data Systems 14, as well as the Risk System 40, is shown schematically in FIG. 3.

By way of example, when a loan is approved, various exceptions can occur that are tracked by the system, and collected in the Exception System 20. Any number of risk events can trigger an exception, such as actions taking place during loan approval that deviate from the loan policy, or where requirements of the loan policy are waived or circumvented for particular transactions or customers. The types of exceptions that are contemplated may vary, and the ability to analyze and manage exceptions will be part of the Exception System 20 software structure. Some examples of risk events that may result in exceptions, in addition to those noted in connection with the Loan Accounting System 18, include, but are not limited to: detected changes in real-time data feeds; covenants identified as unfulfilled; detected changes in client credit scores; or, global changes or world events that may impact financial investments or financial instruments.

For example, a computer program such as an Event Monitor 76 may be used to examine the data in the Exception System 20, or to set or reset the data in the Exception System 20. Exceptions can be tagged and collected in the Exception System 20 by the system automatically reviewing the data in the Origination System 16, the Loan Accounting System 18, or by comparing financial portfolio data to other Risk Data Systems or files accessed by the system.

The system may be automated so that exceptions may be categorized and placed in subfolders or files. For example, a certain type of exception may be automatically placed in a certain file or folder within the Exception System 20 for later use by the Risk System 40. As an example, the flow of data from any of the Risk Data Systems 14 to the Exception System 20 is shown as a flow chart in FIG. 4. An example of the flow of date from the Loan Accounting System 18 to the Exception System 20 is shown as a flow chart in FIG. 5.

It is appreciated that certain types of risk may be placed in several folders or files. Priorities can be determined, items that require follow-ups tracked, trends, volumes and multiple exceptions can change risk or follow-up. The exceptions, all of which are risk events, will be stored and/or logged to the Exception System 20 itself, and may also be logged to one or several other components of the risk management system, such as one or more of the repositories of the Risk Analysis File 44.

D. Derivative System

A derivative is a transaction or contract where the value derives from the value of an underlying asset such as stocks, bonds, mortgages, market indices, foreign currencies, etc. A derivative allows a party with exposure to transfer some or all of the risk to a second party. A Derivative System 22 processes the information comprising a financial institution's derivatives. The Derivative System 22 is in communication with and feeds information to the Risk System 40. The Derivative System 22 may be implemented as a computer program, or in an alternate embodiment, provided as a module in the Loan Accounting System.

A derivative may be a financial instrument that has many variations, such as: credit swaps (insurance; one party takes the risk of repayment for a fee); interest swaps (fixed rate for a variable rate); or, currency swaps (one party trades currency risk for original lender).

E. External Rating System

External rating can be defined as an assessment of a financial institution's creditworthiness. An External Rating System 24 processes information relating to a financial institution's external rating. The External Rating System 24 is implemented as a computer program in communication with and feeding information to the Risk Rule Engine 42.

F. Covenants System

A covenant is an agreement whereby a borrower promises delivery of certain things, or promises performance at a certain level, or vouches for the truth of certain facts as consideration for a loan. Generally, a covenant is an agreement between a financial institution and a client on details of lending agreement. The lender has stipulations the borrower agrees to, such as debt outstanding dividends paid, salaries to owners, movement of assets, real estate stipulations, e.g. owner occupied, rental rates, occupancy. A Covenant System 26 according is implemented as a computer program that processes the collection of promises relating to a particular loan, financial instrument or transaction.

G. Account Analysis System

Financial institution may aggregate and process the information regarding a user's usage of payment or deposit information in an Account Analysis System 114. Such information may comprise: the balance history by day; the wire activity; overdraft information; coin activity; number of deposits; number checks; float; and, other related information. The Account Analysis System 114 may be implemented as a computer program for processing account information.

H. Recovery System

When a financial instrument is determined in default a financial institution may determine if a portion is recoverable. There may be a portion recoverable through collateral, guarantees, offset of balances, real estate or any secured attachable, account receivables and other financial assets. A Recovery System 116 may be implemented as a computer program that processes information related to such recoveries. In determining risk, the amount at risk may be influenced by the balance that will be anticipated to be recoverable.

I. Trust System

A Trust System 32 may be provided as a computer program for processing information regarding any trusts or trust portfolios maintained for clients.

J. Deposit System

A Deposit System 34 may be provided as a computer program for processing deposit activities relating to client accounts.

K. Credit Information Services System

There are various financial information services that provide information regarding parties'credit. Sometimes these are subscription services providing information external to a financial institution. A Credit Information Services System 36 may comprise a computer program or database provided by a third party provider of credit information that may be accessed by the Risk System 40.

L. Business Fundamentals/Industry Data System

General data relating to the financial, lending or banking fields may be collected and processed in a Business Fundamentals/Industry Data System 122.

M. Real-Time Data System

Information may be provided to the risk management system of the present inventions by third party systems comprising real-time finance or baking-related data via a Real-Time Data System 120, which may be implemented as a computer program for processing real-time data provided by third parties. This real-time information may be provided by subscription service, or may be accessed over the internet World Wide Web. Real-time data processes by the Real-Time Data System 120 may take the form of industry reports, global events information, worldwide financial stock market information, etc.

The Risk System 40 is in communication with each of the above-listed Risk Data Systems 14, and may derive data from one or each of the above-listed files in order to perform risk assessment or risk evaluation. It is appreciated that other files may be added by a user of the risk management system comprising information that may impact risk assessment. As new risk data system arise, or as new financial services become available, these may be integrated into the system.

II. Risk System

As used herein, the term “Risk System” is used to describe the collection of computer programs, including files, databases, data stores, and/or modules, or any combination thereof, working independently or in combination, and designed to perform risk assessment and risk evaluation. The Risk System 40 may be implemented as a computer program having various application and data files for storing information on at least one computer having a memory capacity.

A. Risk Rule Engine 42

The Risk System 40 comprises a Risk Rule Engine 42. The Risk Rule Engine 42 executes risk assessment and risk evaluation rules by responding to risk events, requests, and/or scheduled analysis, and executing rules, which may include routines and/or actions, relevant to the various Risk Data Systems 14. Execution of these rules may require access to content in the Risk Analysis File 44 and all information of the system available through the System Interfaces 82, discussed in detail below. Results of the processes of the Risk Rule Engine 42 may be returned to the source data file or Risk Data System 14, generated as an action communicated to a user via the Risk Workflow Engine 104, or utilized for updating the Risk Analysis File 44.

The Risk Rule Engine 42 comprises a computer program operating on at least one computer. The Risk Rule Engine 42 is in communication with the other components of the system. The Risk Rule Engine 42 dynamically receives and processes information regarding risk events from other system components. The Risk Rule Engine 42 is fed by the various Risk Data Systems having information impacting financial risks, as shown in FIGS. 1 and 3, and discussed further below.

The Risk Rule Engine 42 provides a user with the ability to have information collected and included in a Risk Analysis File 44. The Risk Rule Engine 42 is designed to provide an assessment of risk events, which may include by way of example and not by way of limitation: any and all exceptions; employment practices; users, products, and business practices; damage to assets; business disruption and system failures; and execution, delivery, and process management.

The Risk Rule Engine 42 may have rules within the structure of the computer program to automatically process or otherwise manage the data relating to various risk events. For example, the computer program of the Risk Rule Engine 42 may have automatic rules so that if a borrower's credit rating changes, the Risk Rule Engine 42 may automatically sends a notification to a user via the Risk Workflow Engine to a user. The computer program of the Risk Rule Engine 42 may have automatic rules so that if a financial instrument is downgraded, a report is automatically generated. If a combination of particular risks occurs, the Risk Rule Engine 42 may have automatic rules for notifications of that combination. A user of the risk management system can select from many factors that the user wants analyzed by the Risk Rule Engine 42, or can set for any automatic analysis and reporting.

In addition to other components of the system that feed loan or other financial data to the Risk Rule Engine 42, the Risk Rule Engine 42 is designed to access information concerning many variables that are important in determining risk for a financial institution. For example, deposit balances, regulatory requirements, and outside credit ratings, are all examples of important information considered by the Risk Rule Engine 42 when analyzing risk, and are datum points to be considered for defining risk events and determining compliance with the loan policy.

The Risk Rule Engine 42 is adapted, in one aspect, to collect data from the Risk Data Systems 14, and analyze the data using formulas based upon risk management principles to assist a user of the system in managing risk. For example, during the analysis of the data collected from the Exception System 20, the Risk Rule Engine 42 is equipped to determine the quantification, prioritization, working structure, and potential presentation of risk events.

Information may be gathered by the Risk System 40 and Risk Rule Engine 42 by communicating with other components of the system, either directly as shown in FIG. 3, or through System Interfaces 82, as shown in FIG. 6, and discussed in detail below. Predetermined rules may be built into the software of the Risk Rules Engine 42. The software may be designed with routines to automatically search the Risk Data Systems 14 for information relevant to risk assessment. The software may be further designed with routines that are initiated automatically upon the occurrence of a risk event, or may be initiated manually by a user of the system.

The rules contained in the Risk Rule Engine 42 will be extensive and may be constantly evolving. The Risk Rule Engine 42 may further comprise an intelligent computer program that will indicate where further risk review is needed. Because risk assessment and risk evaluation comprise a combination of known issues and new or unknown events, the development of rules within the software of the Risk Rule Engine 42 will be a dynamic and fluid process.

The Risk Rule Engine 42 may be designed with rules for analyzing risk-related data based upon various categories. For example, a particular industry may be identified. The Risk Rule Engine 42 will be designed to analyze the risk involved with a particular industry by considering such factors as: exposure; exposure with credit rating; exposure with maturity; exposure with derivative position; exposure with priority exceptions; or any combination thereof. Measuring these factors will provide a measure of financial portfolio exposure.

The Risk Rule Engine 42 may be designed with rules for measuring a combination of risk events, for example, overdue payments, over-margin collateral, principal exceeding approval line, and other factors may be checked against such risk events as credit ratings, deposit balances, and activities of a particular financial institution employee. These are only examples, but give some insight into the vast capabilities of the risk management system of the present invention.

B. Risk Analysis File

The Risk System 40 further comprises a Risk Analysis File 44 in communication with the Risk Rule Engine 42, as shown in FIG. 7. The Risk Analysis File 44 is adapted to provide storage of data, rules, calculations, parameters, exposures, and unresolved actions associated with identification, analysis and management of risk by the Risk Rule Engine 42. This may comprises, but is not limited to, any or all of the following components, as well as other components that may be uniquely added by a user or at the request of a user:

1. Risk Calculator Repository

A Risk Calculator Repository 46 stores rules, routines and/or formulas for mathematically calculating, quantifying or attempting to predict potential risk. There are many known calculations in the financial and lending industry, and those in the art will be familiar with the formulas that can be used to calculate risk. Formulas may be applied to data collected by routines set to process risk events, user requests, or scheduled analysis. Examples of risk-related formulas are: PD, Probability of Default, EL, Expected Loss, LGD, Loss Given Default, etc. Other formulas used by the risk rules engine and in the Event Filters may be stored in this repository as well. For example, the Risk Calculator Repository 46 may store rules and/or formulas for calculating credit risk according to established ratings definitions.

Probability of Default (PD) measures the risk that a borrower will be unable or unwilling to repay its debt in full or on time. The risk of default is derived by analyzing the borrower's ability to repay a loan in accordance with the loan terms. Loss Given Default (LGD) is the financial loss a financial institution may sustain if a borrower cannot or will not repay its debt. Expected Loss (EL) is the product of PD x LGD. Exposure at Default (EAD) is the amount that may be lost if a borrower defaults. Another formula may be set within the Risk Calculator Repository 46 to determine “credit loss per exposure”, which is calculated as EAD ×LGD ×PD. Each of these formulas may be stored in the Risk Calculator Repository 46 for use in calculating risk. In addition, users of the system can develop and enter their own formulas within the Risk Calculator Repository for assessing risk.

The Risk Calculator Repository 46 may comprise any number of risk formulas, depending on the needs of a financial institution. Other examples of risk formulas for calculating potential risk, included, but are not limited to: PD rating at and prior to default; PD risk factor data prior to default; actual default rates by rating grade; LGD rating at default by exposure; maturity by exposure; portfolio CRM and rating migration; LGD risk factor data prior to default; cash collections; collateral; portfolio CRM received; actual exposure at default; and, EAD rating at exposure by default.

By applying a formula of the Risk Calculator Repository 46, the Risk Rule Engine 42 is able to analyze the data gathered by the Risk System 40, and provide useful information to a user for assessing risk. In this manner, the Risk Rule Engine 42 is capable of researching and reporting (via a User interface) the various types of risk, establish quantification, change parameters, model, manage the variables and in general establish an understanding of the risk profile of the lending process and portfolio. By accessing and analyzing data from the various components of the system, a user is given a tremendous amount of flexibility in assessing and managing risk.

2. Analysis Rule Repository

An Analysis Rule Repository 48 is provided for storing rules that control the access and collection of data to support the analysis of a specific event, request, or scheduled analysis, and apply the appropriate risk calculators for the source and/or content being evaluated. If a risk is identified, the Analysis Rule Repository 48 will apply rules which dispatch action rules, described below.

3. Action Rule Repository

An Action Rule Repository 50 stores rules that determine the action required as a result of a risk event identified during the evaluation of an analysis rule. Such actions may include one or more of the following, as shown in FIG. 7:

a. Notification Routine 52

Users may be notified of risk by the risk management system through the Notification Engine 108 via e-mail, pager, fax, or other methods as required.

b. Action Routine 54

Users may be assigned tasks to perform through the Risk Action Joblist 110 , which generates an action on the user's Joblist, which must be addressed or routed to the appropriate person responsible for resolving, mitigating, or analyzing the risk.

c. Exposure Routine 56

Execution of the rule may result in submissions to the Exposure Repository 62, which is used in future evaluations of risk. Examples of such submissions are: recording of securities pledged as collateral in a “New Loan” event, recording risk parameters that change as a result of loan policy changes, or recording of an updated status on a risk action that was dispatched.

4. Scheduled Analysis Repository

The Scheduled Analysis Repository 58 stores a list of automated requests that are to be performed periodically by the system, based on events that take place, or based upon a prescheduled time. Entries in the Scheduled Analysis Repository 58 trigger the running of analysis rules based on a scheduled analysis, or based upon the occurrence of an event criteria specified by a user.

5. Risk Policy Repository

A Risk Policy Repository 58 stores parameters and rules that define a financial institution's specified and individualized policies for managing risk. Such parameters and rules may be, by way of example, approval and rejection of loans, establishing lending limits based on lender, loan product type, pledged collateral, industry classification, and portfolio composition, assignment of parameters associated with risk calculators, acceptable debt to equity ratios, risk matrixes that involve multiple variables, as well as other parameters that are used in assigning risk or making policy decisions.

6. Exposure Repository

An Exposure Repository 72, as shown in FIG. 9, is provided for storing all information required to assess risk that is not available elsewhere in the system. The information stored in the Exposure Repository 72 may comprise:

a. Interim Calculations File 64

Snapshots of financial information to which current information is to be compared.

b. Summaries File 66

Summarized exposure information to be used in evaluating data streams with Event Filters, to identify equity or currency fluctuations that affect portfolio valuations and risk.

c. Time-Stamped Data File 68

Snapshots of equity, futures, and currency prices to be used in comparing to current values and identifying trends, acceleration, and technical trading patterns.

d. Risk Action Status File 70

Current status of all open risk actions recorded by the Risk Workflow Engine 104.

7. Exception Repository

An Exception Repository 72 stores policy exceptions submitted to the system, and permits access to exceptions as required in evaluating an analysis rule. As discussed, such exceptions include, but are not limited to, any risk event, loans that are approved at variance with policy, loan that are conditionally approved, or any exception to the loan policy or an operating procedure that must be recorded or tracked.

8. Covenant Repository

A Covenant Repository 74 stores all agreements, promises, or criteria upon which the conditional approval of a loan, relationship, or contract is established. The Covenant Repository 74 maintains requirements and/or criteria that enable the Risk Rule Engine 42 to evaluate whether the conditions of the covenant are met. The Covenant Repository 74 provides access to covenant information as required by the execution of analysis rules, and generates exception events that trigger risk evaluation for expired covenants that are not fulfilled.

It is appreciated that other repositories may be added to the Risk Analysis File 44, containing rules or data necessary for risk assessment.

C. Event Monitor

As shown in FIG. 10, an Event Monitor 76 may be provided as a component of the Risk System 40. The Event Monitor 76 monitors data from the Risk Data Systems 14 regarding risk events or other data external to or internal to a financial institution. Examples of internal events include: changes to covenant status (fulfilled, expired, etc); selected new exceptions registered in the exception system; changes in collateral pledges in the loan system, etc. Examples of external data include financial news reports from third parties. The Event Monitor 76 submits the information regarding any risk event to the Risk Rule Engine 42 for evaluation by a rule or designated action relevant to the submitted event.

The Event Monitor 76 may also have a periodic review function. The periodic review function will monitor the Risk Data Systems 14, or any other data sources that a user wishes the Risk System 40 to access, on a scheduled basis.

D. Event Filter

An additional Event Filter 78 may be further provided for receiving data regarding selected risk events identified by accessing real-time data. The Event Filter 78 is in communication with the Risk Rule Engine 42, as well as the Risk Data Systems 14, either directly, or through System Interfaces 82. Real-time data is filtered for specific variances and conditions based on rules and calculators defined in the Risk Rule Engine 42 and /or Risk Analysis File 44. The Event Filter 78 submits only selected event information to the Risk Rule Engine 42 for evaluation by a rule relevant to the event.

E. Inquiry Dispatcher

An Inquiry Dispatcher 80 may be provided as an interface computer software component having rules for dispatching inquiries to Risk Data Systems 14 through one or more of the System Interfaces 82 described below. The Inquiry Dispatcher 80 may be responsible for converting and/or mapping automated risk event requests to a form recognizable by a particular interface, and for interpreting the response. The Risk Rule Engine 42 may invoke the Inquiry Dispatcher 80 to collect or extract data as required during execution of rules associated with an event or a request.

The Inquiry Dispatcher 80 may also be designed to direct some of the automatic processes of the Risk System 40, such as periodically reviewing the Origination System 16 for exceptions.

F. System Interfaces

The Risk System 40 may comprise System Interfaces 82 for processing, accessing, managing and/or routing information from the various Risk Data Systems 14 used by the system for analyzing risk. The Risk System 40 requests and may respond to information from multiple sources, both internal and external to a financial institution. Information may be received in response to a risk event, a message initiated by another source, requests initiated by a user, or by the automated resources and functions of the risk management system. The risk management system responds to this information as dictated by the rules stored in the Risk Analysis File 44.

The System Interfaces 82 may be implemented as computer programs that that are run in various ways. For example, the System Interfaces 82 may be programmed for batch runs, where one of the System Interfaces 82 automatically performs a set task at a set time. The System Interfaces 82 may be programmed to access and manage real-time information provided by data feeds. The System Interfaces 82 may further be programmed to inquire into the Risk Data Systems or other data sources to obtain a “snapshot” of the risk as it exists as a particular time.

The System Interfaces 82 may include, but are not limited to:

1. Covenants Interface

A Covenants Interface 84 provides access to the Covenants System by receiving risk events related to scheduled covenants and compliance status.

2. Exception Interface

An Exception Interface 86 provides access to the Exception System 20 by receiving selected exceptions as they are logged into the Exception System 20, and responds to inquiries from the Inquiry Dispatcher 80 or Risk Rule Engine 42 for exception information.

3. Loan Accounting Interface

A Loan Accounting Interface 88 provides access to the Loan Accounting System 18 for new loan bookings and relevant changes to existing loans, including transactions, changes in collateral, changes in terms, etc., and responds to inquiries for loan information. The Loan Accounting Interface 88 permits updated transactions to maintain risk-related criteria for performance-based pricing of loans.

4. Origination Interface

An Origination Interface 90 provides access to the Origination System for new loan applications and changes in ongoing loan applications.

5. Trust Interface

A Trust Interface 92 provides access to the organization's trust account information as required for executing analysis rules.

6. Derivative Interface

A Derivative Interface 94 provides access to a financial institution's Derivative System as required for executing risk assessment and risk evaluation rules.

7. Deposit Interface

A Deposit Interface 96 provides access to a financial institution's deposit file by responding to inquiries for deposit, account balance, and transaction history information.

8. Live Datafeed Channel Interface

A Live Datafeed Channel Interface 98 provides access to real-time content generated by Risk Data Systems 14 that deliver a data stream for ongoing transactions. Examples include spot prices and trades in equities, currencies, futures, commodities, derivatives, indexes, and other services from which an ongoing transactional stream of data is provided.

9. Third Party Interface

A Third Party Interface 100 provides access to external sources of data that can respond to inquiries for information. Examples include credit information services, credit scoring, SEC inquiries, business fundamentals services, industry data, and other services that provide financial information on demand.

It is appreciated that the Risk System 40 may be designed using any or all of the interfaces provided herein. System Interfaces 82 may be implemented for each available Risk Data System 14, or for selected Risk Data Systems 82. In addition, the Risk System 40 may directly access information from the Risk Data Systems 14, without the use of interfaces.

G. Transaction Submission Module

A Transaction Submission Module 102 may be provided, for composing and submitting transactions in a form acceptable to the Loan Accounting System 18 for posting changes to loan terms that are affected by a risk component or event. For example, it may be necessary to post a change to the Loan Accounting System 18 regarding transactions to maintain risk-related criteria for performance-based pricing of loans. The Risk Rule Engine 42 will automatically prepare such changes for use in the Loan Accounting System 18, and these will be executed by the Transaction Submission Module.

H. Risk Workflow Engine

As shown in FIG. 12, a Risk Workflow Engine 104 is provided in communication with the Risk Rule Engine 42 for generating notification messages and reports, and initiating or maintaining workflow requests that are routable to system users responsible for actionable items identified by the Risk Rule Engine 42. The Risk Workflow Engine 104 provides services through the Notification Engine 108 and Risk Action Joblist 110 described herein.

1. Notification Engine

In using the system, it is necessary that users are notified when certain risk-related events occur, or when certain actions take place. The parameters for notifications may be set by the user. To accomplish notification, the Risk Rule Engine 42 further comprises a Notification Engine 108. The Notification Engine 108 provides a means for dispatching notification messages to users as a result of required actions automatically determined by the Risk Rule Engine 42. The Notification Engine 108 sends notification messages automatically to users based on parameters set in the Risk Rule Engine 42. Methods of notification through the Notification Engine 108 include, but are not limited to, email, pager, fax, text messages, etc. In this manner, a user is kept apprised of potential risk as identified by the system.

2. Risk Action Joblist

The Risk Rule Engine 42 further comprises a means for users to keep track of and assign risk-related tasks. Thus, the Risk Rule Engine 42 further comprises a Risk Action Joblist 110. The Risk Action Joblist 110 provides access, through the Risk Workstation 112, to a list of ongoing or in-process actions assigned to a particular user of the system, or to be monitored by a user. For events identified by the risk management system as risk-related events, entries are added to a joblist file of each responsible user. The items in the joblist file are reported to the user via the Risk Action Joblist 110 function or the Risk Workstation 112. The user responds to these actions and reports status to the Risk Action Joblist 110 or routes the action to another user for resolution.

The Risk Workflow Engine 104, Risk Action Joblist 110 and Notification Engine 108 are designed to interpret real-time data provided by real-time data feeds. In addition, the Risk Workflow Engine 104, Risk Action Joblist 110 and Notification Engine 108 provide means to invoke user actions based upon risk events. The workflows created by these components of the risk management system provide users with lists of actions that need to be taken, or may be taken, based upon risk events. A Joblist will comprise actions items, providing a log for users. The Risk Workflow Engine 104, Risk Action Joblist 110 and Notification Engine 108 may be used to delegate actions that need to be taken by a user. These actions may be prioritized based on a user's preference.

I. Risk Workstation

The Risk Rule Engine 42 communicates with users through at least one user interface presented on a user's computer desktop. In an illustrative embodiment, the user interface is implemented as a Risk Workstation 112 comprising a user interface, such as a graphical user interface or GUI, which is a set of commands or menus through which a user communicates with a computer program via a personal computer. Communication is initiated by a user (i.e., by requesting information from the system, or changes to risk parameters), and by the risk system (by automatically providing notifications and carrying out assigned actions). Users initiate inquiries through the Risk Workstation 112 to access risk management information, change parameters that affect risk evaluation, and respond to notifications and requested actions involving the risk management system.

In addition, the Risk Workflow Engine can be used to generate necessary forms and documents, such as documents needed to comply with, for example, Basel legislation. This documentation generation function can be automated by a user of the system to create selected reports.

An illustrative example of the operation of the Risk Workstation 112 follows. According to the process described above, the Risk Rule Engine 42 identifies a risk caused by documentation missing from a loan. A risk calculator processed by the Risk Rule Engine 42 assesses the level of risk involved in the risk event. Using the Risk Workstation 112, a user accesses the risk assessment, and may view the information regarding the operational risk as a table, chart, pie chart, bar graph, etc., or other graphical or textual representation. In addition, the user may have the system present information regarding the severity of such a risk as compared to financial institutional factors. The Risk Workstation 112 may be further designed to provide reports and documentation, whether written or electronically, for users. The documentation process may be automated, so that certain documents are automatically generated by the system based upon a financial institution's particular needs, or preselected settings.

One of the many improvements of the risk management system of the present invention over known systems, is the system of the present invention is capable of providing real-time assessment of risk to a user. Thus, utilizing a Risk Workstation 112, a user is able to immediately capture and appreciate a level of risk associated with loans being serviced by a user as those risks occur.

### EXAMPLES OF RISK MANAGEMENT SYSTEM AT WORK

Taken as a whole, a goal of the risk management system of the present invention is to provide an ongoing system for monitoring the financial health of a financial institution as it relates to potential risks, and to provide tools for taking action to mitigate risk. The risk management system of the present invention may be grouped into components for detection of risk, analysis of risk, and control (or mitigating) of risk. For example, the various Risk Data Systems, Systems Interfaces, Event Monitor and Event Filter act to detect risk. The Rusk Rule Engine and Risk Analysis File act to analyze risk. The Risk Workflow Engine, Risk Action Joblist, and Notification Engine act to control risk. For the first time, the risk management system of the present invention collects data that has otherwise been reviewed in an ad hoc manner, and provides a way to utilize that data to meaningfully assess and manage risk.

It is apparent that the risk management system of the present invention can be an invaluable tool to any financial institution. The risk management system can analyze individual exceptions, as well as combinations of exceptions. For example, a combination of risks events may occur such as a financial portfolio having overdue payments, over margin collateral, and principal exceeding approved line. These can be analyzed in combination using the Risk System 40.

The system is designed to process, among other types, operational, credit and strategic risks that result in exceptions. Operational risk exceptions could be minor exceptions that require such actions as sending a letter, or the correction of a portion of data. When considered individually, the true nature of exceptions may not be apparent. However, when individual data points in the Exception System 20 are evaluated by the Risk Rule Engine 42, and combined with or considered in light of other data, the true severity of the risk caused by an individual exception can be examined. When considered collectively, exceptions can change priority and management of a particular loan account or portfolio.

The Risk Workstation 112 of the system provides users the ability to select, such as by any acceptable means such as checking boxes or otherwise making selections from a file menu provided on a computer screen, various risk events to be analyzed. The Risk Workstation 112 may also have menus for various actions that may be executed at the user's request. By selecting combinations of risk events and system actions, risk may be analyzed in many ways.

An illustrative example us provided as shown in FIG. 13. The Exception System 20 detects a deviation from the loan policy, and records the exception as a risk event. The Risk System 40 retrieves the data regarding the risk event from the Exception System 20. The Risk System 40 may retrieve the data regarding the risk event via the Event Monitor 76, or the Exception Interface 86, or the Inquiry Dispatcher 80. The Risk Rule Engine 42 may also be adapted to directly retrieve the data regarding the risk event from the Exception System 20. The Risk System 40, via the Risk Rule Engine 42, retrieves the risk analysis rule relevant to the risk event from the Risk Analysis File 44. According the risk analysis rule of this example, the Risk Rule Engine 42 directs the Loan Accounting Interface 88 to retrieve data regarding a particular client's loan from the Loan Accounting System 18. Note that the information retrieved will effectively be in real-time, meaning that the risk even at issue is being assessed against the client's loan portfolio data as that data exists at the time of the inquiry. The Loan Accounting Interface 88 forwards the requested data to the Risk Rule Engine 42 for risk assessment. The Risk Rule Engine 42 assesses the risk event against the client's loan policy data using any appropriate rules or data in the Risk Analysis File 44. Results of the risk assessment are forwarded to the Risk Workflow Engine 104. The Risk Workflow Engine 104 notifies a user of the risk assessment via the Notification Engine 108. The Risk Workflow Engine 104 may also update the Risk Action Joblist 110, assigning a task to a particular user related to the risk event and assessment of the risk event. A user accesses the results of the risk assessment via a Risk Workstation 112.

Another example of the risk management system of the present invention at work would be the evaluation of ongoing risk related to a client's deposit information. In this example, the Risk Rule Engine 42 processes rules accessed from the Scheduled Analysis Repository 58 of the Risk Analysis File 44. The Risk Rule Engine 42 additionally processes, at a preselected time, a rule and/or routine relating to analyze deposits, for example a deposit analysis rule, that is scheduled on a nightly basis. The Risk Rule Engine 42 requests data relating to deposits from the Deposit Interface 96. The Deposit Interface 96 requests and receives information regarding deposits from the Deposit System 34. The Deposit Interface 96 forwards requested deposit data to the Risk Rule Engine 42. The Risk Rule Engine 42 accesses loan policy information for risk assessment as required by the deposit analysis rule. The Risk Rule Engine 42 evaluates deposit balances and deposit activity as compared to loan policy. The Risk Rule Engine 42 updates the Exposure Repository 62 with data regarding the deposit conditions. Any risk events detected during the processing of the deposit analysis rule are forwarded to the Results of the risk assessment are forwarded to the Risk Workflow Engine 104. The Risk Workflow Engine 104 notifies a user of the risk assessment via the Notification Engine 108. The Risk Workflow Engine 104 may also update the Risk Action Joblist 110, assigning a task to a particular user related to the risk event and assessment of the risk event. A user accesses the results of the risk assessment via a Risk Workstation 112.

Another illustrative example of how the risk management system of the present invention can assess and evaluate risk would be in handling a credit alert. A credit alert may occur if a customer is requesting a loan while the customer's current loans have repayment issues, deposit balance deficiencies, significant third party rating changes, international domiciles, or similar issues. The loan policy is set to contain a rule that a credit alert triggers an exception. Once a credit alert occurs, the credit alert is noted to the Exception System 20. The Risk Rule Engine 42 accesses the information stored in the Exception System 20 regarding the credit alert via the Exception Interface 86. In addition, the Event Monitor may automatically obtain information regarding the credit alert. The Risk Rule Engine 42 analyzes the credit alert based upon criteria set in the Risk Analysis File 44. The results of the analysis are forwarded to the Risk Workflow Engine 104 for eventual access by a user through the user interface. In addition, the Risk Rule Engine 42 may send a message to the Loan Accounting System 18 via the Transaction Submission Module and/or Loan Accounting Interface for updating the financial portfolio in the Loan Accounting System 18.

An example of the processing of a risk event detected in the Loan Accounting System is shown in FIG. 14.

The ability to anticipate or report on possible fraud efforts is another important aspect of the system. Another illustrative example of how the system can assess and manage risk would be the assessment of operational risks, such as documents not being available during origination, or incorrect data entry, or an attempt to input new loan data as a loan approaches maturity. Any of these occurrences would be considered a deviation from the loan policy. The system channels any such operational risks to the Exception System 20, for access by the Risk Rule Engine 42 via the Exception Interface. The Risk Rule Engine 42 accesses the information from the Exception System 20 regarding the operational risk. The Risk Rule Engine 42 may access and apply a formula from the Risk Calculator Repository of the Risk Analysis File 44 designed to calculate the magnitude or operational risk based upon the exception identified by the system.

Credit risk and strategic risk may be identified and analyzed by the system by reviewing for one or more of many types of risk factors, such as country balances, increasing exposure to various balance positions, loan balance to deposit, loan balance to covenant, and deposit balance or credit rating. Formulas may be set in the Risk Calculator Repository to quantify such risks.

Credit risk exceptions also come in many types, from limits, to legal filings, to covenants and the like. Strategic risk exceptions could be exceptions that identify deviations in areas, countries, industries, or loan products to name a few examples. Risks may also be considered in several categories, for what might be a strategic risk could be considered a credit risk as well. Operational risks can easily be thought to be credit risks. The current approach is that the operational risks should be managed separate from the credit risk.

Strategic and credit risk will also be developed by gathering information in the Exception System 20 from the Loan Accounting System 18 files. Subsequent to the approval of the loan, exceptions can be developed by events that occur throughout the life of the loan. Examples of this type of exception include large payoffs which cause the concentration balances of the financial institution's remaining loans to exceed set strategic goals and cause economic changes which could affect the financial institution's loan policy, causing an exception.

In all types of exceptions, reporting will be established to enable the proper understanding of the issues as well as the appropriate steps necessary to work through the removal of the discovered risk. In an illustrative embodiment, reporting is accomplished through at least one computer terminal, a Risk Workstation 112, provided to a user in communication with the Risk Rule Engine 42.

The Risk Workstation 112 allows a user access to a vast amount of risk-related data. A group of predetermined screens and reports may be provided that may be tailored to the needs of a particular user. With the free form penetration capability of the Risk Rule Engine 42, the reporting and presentation of information can have various formats, including, but not limited to, reports, charts, graphs, comparisons, etc. Different areas of a financial institution will have a desire to view the risks in a particular fashion.

The Risk Workstation 112 is extremely flexible, and is equipped with analysis and display options to provide assurance of further detailed understanding. The Risk Workstation 112 is equipped to display many types of views and necessary steps according to the financial institution's determination. Optional reports may include a required action timetable, a summary by department or type, an automatic referral to other individuals, or other options.

It is understood that the present invention is not limited to the particular embodiments shown and described herein, but that various changes and modifications may be made without departing from the scope and spirit of the invention.

What is claimed is:

1. A risk management system, comprising:
a. a loan policy system comprising a loan policy, the loan policy comprising a set of rules;
b. at least one risk data system in communication with the loan policy system;
c. a risk system in communication with the loan policy system and the risk data system, the risk system adapted to process data from the loan policy system and the risk data system for the purpose of performing risk assessment; and,
d. a user interface in communication with the risk system for reporting the result of the risk assessment.

2. The risk management system according to claim 1, wherein the risk system further comprises a risk rule engine for performing risk assessment, the risk rule engine in communication with the loan policy system and the risk data system.

3. The risk management system according to claim 2, wherein the risk system further comprises a risk analysis file, the risk analysis file in communication with the risk rule engine, the risk analysis file adapted to process and store data for risk assessment.

4. The risk management system according to claim 1, wherein the risk data system comprises an exception system.

5. The risk management system according to claim 1, wherein the risk data system comprises an origination system.

6. The risk management system according to claim 1, wherein the risk data system comprises a loan accounting system.

7. The risk management system according to claim 1, wherein the risk data system comprises an external rating system.

8. The risk management system according to claim 1, wherein the risk data system comprises an external rating system.

9. The risk management system according to claim I, wherein the risk data system comprises a covenants system.

10. The risk management system according to claim 1, wherein the risk data system comprises an account analysis system.

11. The risk management system according to claim 1, wherein the risk data system comprises a recovery system.

12. The risk management system according to claim 3, wherein the risk analysis file further comprises a risk calculator repository.

13. The risk management system according to claim 3, wherein the risk analysis file further comprises an analysis rule repository.

14. The risk management system according to claim 3, wherein the risk analysis file further comprises an action rule repository.

15. The risk management system according to claim 14, wherein the action rule repository further comprises a notification routine.

16. The risk management system according to claim 14, wherein the action rule repository further comprises an action routine.

17. The risk management system according to claim 14, wherein the action rule repository further comprises an exposure routine.

18. The risk management system according to claim 3, wherein the risk analysis file further comprises a scheduled analysis repository.

19. The risk management system according to claim 3, wherein the risk analysis file further comprises a risk policy repository.

20. The risk management system according to claim 3, wherein the risk analysis file further comprises an exposure repository.

21. The risk management system according to claim 20, wherein the exposure repository further comprises an interim calculations routine.

22. The risk management system according to claim 20, wherein the exposure repository further comprises a summarizations routine.

23. The risk management system according to claim 20, wherein the exposure repository further comprises a timestamped data routine.

24. The risk management system according to claim 20, wherein the exposure repository further comprises a risk action status routine.

25. The risk management system according to claim 3, wherein the risk analysis file further comprises an exception repository.

26. The risk management system according to claim 3, wherein the risk analysis file further comprises a covenants repository.

27. The risk management system according to claim 2, wherein the risk system further comprises an event monitor in communication with the risk rule engine and the risk data system.

28. The risk management system according to claim 2, wherein the risk system further comprises an event filter in communication with the risk rule engine and the risk data system.

29. The risk management system according to claim 2, wherein the risk system further comprises an inquiry dispatcher in communication with the risk rule engine and the risk data system.

30. The risk management system according to claim 1, further comprising at least one system interface in communication with the risk data system and the risk system.

31. The risk management system according to claim 30, wherein the system interface comprises a covenants interface.

32. The risk management system according to claim 30, wherein the system interface comprises an exception interface.

33. The risk management system according to claim 30, wherein the system interface comprises a loan accounting interface.

34. The risk management system according to claim 30, wherein the system interface comprises an exception interface.

35. The risk management system according to claim 30, wherein the system interface comprises a trust interface.

36. The risk management system according to claim 30, wherein the system interface comprises a deposit interface.

37. The risk management system according to claim 30, wherein the system interface comprises a live datafeed interface.

38. The risk management system according to claim 30, wherein the system interface comprises a third party interface.

39. The risk management system according to claim 2, wherein the risk system further comprises a transaction submission module in communication with the risk rule engine and the risk data systems.

40. The risk management system according to claim 2, wherein the risk system further comprises a risk workflow engine in communication with the risk rule engine and the risk data systems.

41. The risk management system according to claim 40, further comprising a notification engine in communication with the risk workflow engine.

42. The risk management system according to claim 40, further comprising a risk action joblist system in communication with the risk workflow engine.

43. The risk management system according to claim 1, further comprising a user interface in communication with the risk rule engine.

44. The risk management system according to claim 43, wherein the user interface is a risk workstation.

45. A method for managing risk associated with the services provided by a financial institution, comprising:
a. establishing a loan policy;
b. monitoring data in at least one risk data system;
c. comparing the data to the loan policy in order to determine if the data deviates from the loan policy;
d. recording a risk event when the data deviates from the loan policy;
e. performing risk assessment of the risk event; and,
f. enabling a user to access the results of the risk assessment.

46. The method for managing risk according to claim 45, wherein the risk event is assessed via a risk system.

47. The method for managing risk according to claim 46, wherein the risk system is a computer program implemented on at least one computer and adapted to automatically review the risk data system for the occurrence of risk events.

48. The method for managing risk according to claim 46, wherein the risk system automatically performs risk assessment.

49. The method for managing risk according to claim 45, wherein the step of performing risk assessment of the risk event further comprises comparing the data comprising a risk event to data from a second risk data system.

50. The method for managing risk according to claim 45, wherein a user is enabled to access the results of the risk assessment via a risk workstation.
